(19) United States
(12) Patent Application Publication
(10) Pub. No.: US 2004/0008874 A1
(43) Pub. Date: Jan. 15, 2004

(54) Congeniality determination server, program and record medium recording the program

(76) Inventor: Makoto Koike, Kyoto-Fu (JP)

Correspondence Address: DICKSTEIN SHAPIRO MORIN & OSHINSKY LLP, 2101 L STREET NW, WASHINGTON, DC, 20037-1526, US

(21) Appl. No.: 10/448,114

(22) Filed: May 30, 2003

(30) Foreign Application Priority Data
May 31, 2002 (JP) JP2002-160613

(51) Int. Cl. G06K 9/00

(52) U.S. Cl. 382/118

(57) ABSTRACT

New information is provided based on a photographic image received from a terminal. A congeniality determination server communicates with a user terminal through a public network and the Internet. The congeniality determination server receives a facial image at a communication module, a face's distinctive features based on each received facial image are extracted at a control module and a face type based on the extracted face's distinctive features is determined. Congeniality between two persons corresponding to the combination of the two face types determined from the two facial images is then determined. The congeniality determination server transmits the determined congeniality between two persons from the communication module to the terminal user.

### FIELD OF THE INVENTION

This invention relates to a method and an apparatus for providing information and entertainment based on a photographic image received through a communication network from a user terminal and more particularly to a congeniality determination method and a congeniality determination server for determining congeniality between two persons based on images of two faces.

### BACKGROUND OF THE INVENTION

In recent years, sites for providing various pieces of information and entertainment for the user have been established over the Internet. Particularly, as text information service known as the name of “i mode” (registered trademark) or the like in a mobile telephone system makes it possible for the user to access a site on the Internet from a mobile telephone, a user can easily acquire various pieces of information and entertainment on the Internet from a mobile telephone terminal.

Photographic images are frequently exchanged on the Internet with the widespread use of digital cameras. Particularly, as a mobile telephone terminal having a photographing function become increasingly commercially available, photographic images can be easily exchanged between mobile telephone terminals.

Sites for providing various pieces of information and entertainment based on a photographic image received from a terminal have been created but are of limited use.

### BRIEF SUMMARY OF THE INVENTION

It is therefore an object of the invention to provide new information based on a photographic image received from a terminal for entertainment purposes.

To that end, according to one aspect of the invention, there is provided a congeniality determination method including the steps of acquiring facial images through a communication network; extracting a face's distinctive features based on the acquired facial images; determining face types based on the extracted face's distinctive features; determining congeniality between two persons corresponding to the combination of two facial types determined from the two facial images; and providing the determined congeniality between two persons through the communication network.

According to the congeniality determination method, a face's distinctive features are extracted from each of two photographic images containing facial images, the facial types are determined based on the extracted face's distinctive features, and congeniality between two persons corresponding to the combination of the two determined face types is provided. Therefore, the user can transmit the two photographic images containing facial images from the terminal, thereby acquiring new information of the congeniality between two persons.

The user can also acquire the congeniality between two persons based on the face's distinctive features simply by transmitting the two photographic images from the terminal. Therefore, to acquire the congeniality between two persons based on the face's distinctive features, the user need not transmit several pieces of information indicating the face's distinctive features, so that the user can acquire the congeniality between two persons easily from the user terminal.

Particularly, if the terminal is a mobile telephone terminal having a photography function, the user can easily take a close-up photograph and easily transmit the provided facial image.

The congeniality determination method of the invention may include the steps of storing a plurality of facial images of each person; and selecting a combination of facial images used for congeniality determination from among the plurality of facial images stored.

Generally, the face's distinctive features appearing on the facial image change depending on the expression of a subject at the time the photograph is taken, the positional relationship between the camera and the subject, etc. Thus, if congeniality between the same two persons is determined, the determination may vary depending on the received facial images.

Therefore, according to the congeniality determination method, any of various combinations can be selected from among the facial images of each person for making a congeniality determination, so that the user can acquire various pieces of congeniality information by using a plurality of facial images provided by photographing changed expressions, for example.

According to another aspect of the invention, there is provided a congeniality determination server communicating through a user terminal and a communication network and including an input module for receiving facial images through the communication network; a distinctive feature extraction module for extracting a face's distinctive features based on the received facial images; a type determination module for determining face types based on the extracted face's distinctive features; a congeniality determination module for determining congeniality between two persons corresponding to the combination of two face types determined from the two facial images; and a transmission module for transmitting the determined congeniality between two persons through the communication network.

According to the above configuration, a face's distinctive features are extracted by the distinctive feature extraction module from each of two photographic images containing facial images received at the input module, the face types are determined by the type determination module, and congeniality between two persons corresponding to the combination of the two face types determined by the type determination module is determined and is transmitted by the transmission module to the terminal. Therefore, the user can transmit the two photographic images containing facial images from the terminal, thereby acquiring new information of the congeniality between two persons.

The user can also acquire the congeniality between two persons based on the face's distinctive features simply by transmitting the two photographic images from the terminal. Therefore, to acquire the congeniality between two persons based on the face's distinctive features, the user need not transmit several pieces of information indicating the face's distinctive features, so that the user can acquire the congeniality between two persons easily from the user terminal.

Particularly, if the terminal is a mobile telephone terminal having a photography function, the user can easily take a close-up photograph and easily transmit the provided facial image.

The congeniality determination server of the invention may further include an image storage module being capable of storing a plurality of facial images of each person; and an image selection module for selecting a combination of facial images used for congeniality determination from among the plurality of facial images stored in the image storage module.

Selection of facial images by the image selection module may be executed based on instruction information received from the terminal or may be executed by the congeniality determination server based on a predetermined condition or on a random basis.

According to the configuration, any of various combinations can be selected through the image selection module from among the facial images of each person stored in the image storage module for making a congeniality determination, so that the user can acquire various pieces of congeniality information by using a plurality of facial images provided by photographing changed expressions, for example.

A computer can be caused to execute the congeniality determination method as a congeniality determination program. Further, the congeniality determination program may be stored on a computer-readable record medium, whereby the congeniality determination method can be executed on any desired computer.

### BRIEF DESCRIPTION OF THE DRAWINGS

FIG. 1 is a block diagram of a schematic configuration of a congeniality determination system of one embodiment of the invention;

FIG. 2 is a block diagram of a schematic configuration of a user terminal in the embodiment of the invention;

FIG. 3 is a block diagram of a schematic configuration of a congeniality determination server in the embodiment of the invention;

FIG. 4A is a drawing of a facial image received in the congeniality determination server;

FIG. 4B is a drawing showing an image extracting the distinctive features of the face from the facial image;

FIG. 5 is a drawing showing the determination contents of the distinctive features of the parts of each face in the embodiment of the invention;

FIG. 6 is a table showing facial type comment data of face types and male and female face type comments corresponding to the face types in the embodiment of the invention;

FIG. 7 is a table showing congeniality comment data of congeniality comments corresponding to combinations of the male and female face types in the embodiment of the invention;

FIG. 8 is a flowchart showing the congeniality determination operation of the congeniality determination server in the embodiment of the invention;

FIG. 9 is a drawing showing an image before congeniality determination execution, displayed on the user terminal in the embodiment of the invention; and

FIG. 10 is a drawing showing an image of the congeniality determination result displayed on the user terminal in the embodiment of the invention.

### DETAILED DESCRIPTION OF THE INVENTION

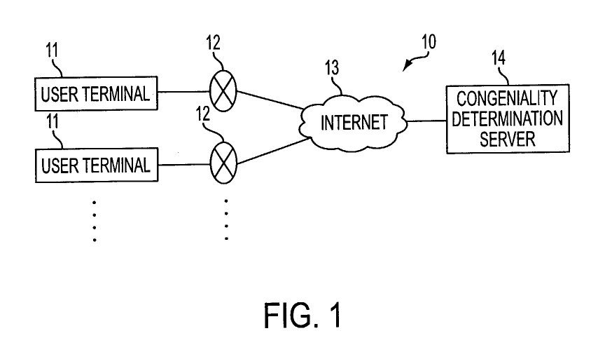

An embodiment of the invention will be discussed with reference to FIGS. 1 to 10. FIG. 1 shows a schematic configuration of a congeniality determination system in the embodiment. A congeniality determination system 10 of the embodiment is a system wherein facial images of two persons are transmitted from user terminals 11 through public networks 12 and the Internet 13 to a congeniality determination server 14 and the congeniality determination server 14 determines congeniality between the two persons based on the facial images of the two persons and transmits the determination result through the Internet 13 and the public networks 12 to the user terminals 11. The components will be discussed below.

As the user terminals 11, a mobile telephone terminal and a PC (personal computer) can be used, but any machine can be used if it can transmit facial image data to the congeniality determination server 14 and receive the congeniality determination result from the congeniality determination server 14. Preferably, the user terminal 11 has a photography function, but need not have a photography function if the user terminal 11 can receive photographic image data provided by a digital camera via a record medium or communications.

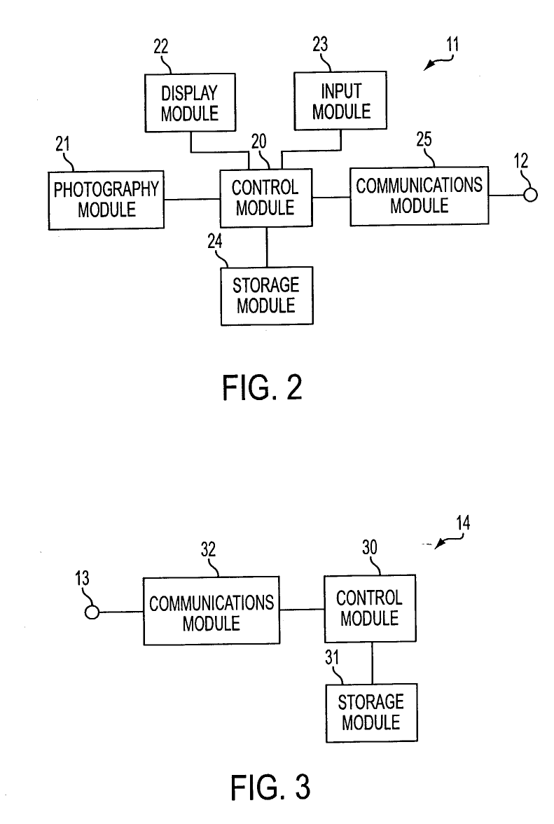

FIG. 2 shows a schematic configuration of the user terminal 11 having a photography function. The user terminal 11 includes a control module 20, a photography module 21, a display module 22, an input module 23, a storage module 24, and a communication module 25. The control module 20 controls the operation of the components of the user terminal 11.

The photography module 21 is implemented as a digital camera having a lens, an image pickup device, etc., and prepares photographic image data by photographing and transmitting the photographic image data to the control module 20. In the embodiment, the photography module 21 needs only to be able to photograph the face portion of a human being and thus need not be provide with a telephoto lens or a wide-angle lens.

The display module 22 is implemented as a display device such as a CRT (cathode ray tube) or an LCD (liquid crystal display) and displays various pieces of information of text, an image, etc., based on display data received from the control module 20.

The input module 23 accepts various entries from the user and includes a large number of input buttons and a keyboard. The input module 23 converts information entered by the user into input data and transmits the input data to the control module 20.

The storage module 24 has storage units of ROM (Read-Only Memory), RAM (Random Access Memory), a hard disk, etc. The storage module 24 can store a control program for performing the control operation of the components in the control module 20, an OS (Operating System) program, other various programs, and various pieces of data.

The communication module 25 communicates with the congeniality determination server 14 through the public network 12 and the Internet 13. The communication module 25 converts data such as image data received from the control module 20 into a format suited for data communications on the public network 12 and then transmits the provided data through the public network 12 to the congeniality determination server 14.

The communication module 25 also converts data such as the congeniality determination result data received through the Internet 13 and the public network 12 from the congeniality determination server 14 into user terminal internal data format and then transmits the provided data to the control module 20.

Any desired public networks 12 such as public switched telephone networks including a fixed analog telephone line, ISDN (Integrated Services Digital Network), PHS (Personal Handyphone System) (registered trademark), mobile telephone system, etc., can be used singly or in combination.

FIG. 3 shows a schematic configuration of the congeniality determination server 14. The congeniality determination server 14 is a www (world wide web) server on the Internet. Thus, the user can view a home page stored in the congeniality determination server 14 by transmitting URL (Uniform Resource Locator) from the user terminal 11. The congeniality determination server 14 includes a control module 30, a storage module 31, and a communication module 32.

The control module 30 controls the operation of the components of the congeniality determination server 14. Operational control of the components in the control module 30 is performed as a control program executed on a computer.

A control program that is recorded on a removable medium such as a CD-ROM may be retrieved for use or a control program that is installed on a hard disk, etc., may be retrieved for use. It is also possible for the control module 30 to download the control program through a communication network such as the Internet and install the control program on a hard disk, etc., for execution.

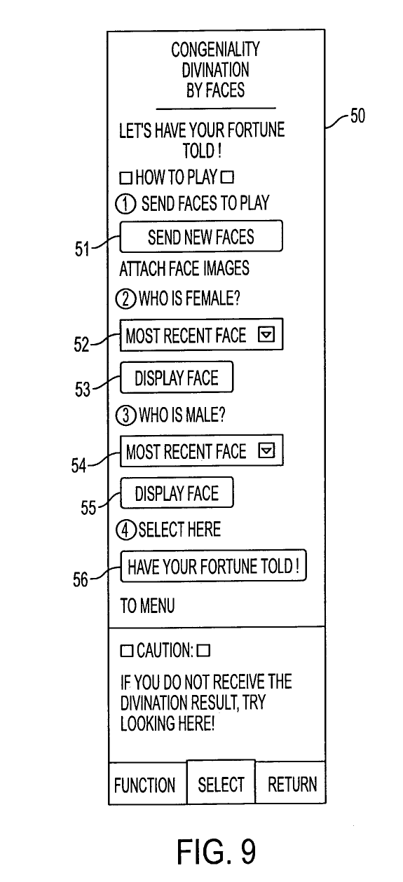

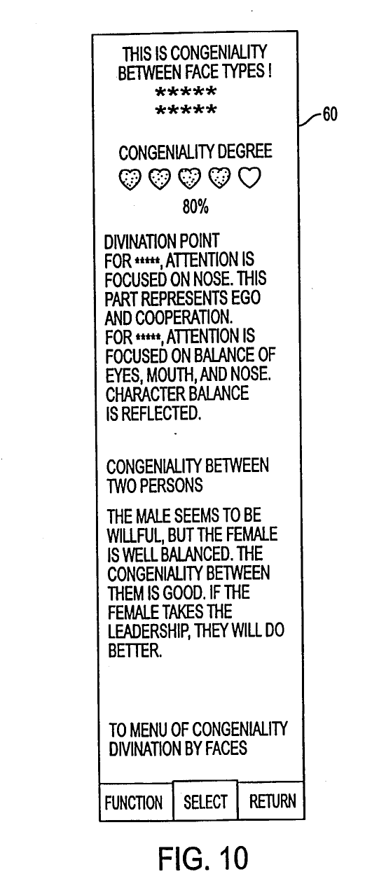

The storage module 31 has storage units of ROM, RAM, a hard disk, etc. The storage module 31 stores various programs and various pieces of data, such as a control program for performing the control operation of the components in the control module 30, an OS program, a congeniality determination program for executing a congeniality determination, home pages to be displayed on the user terminal 11 for the user to perform operation for congeniality determination (FIGS. 9 and 10), facial image data transmitted by the user, a program and data used for congeniality determination (described later), and the like.

The communication module 32 communicates with the user terminal 11 through the Internet 13 and the public network 12. The communication module 32 converts data received from the control module 30 into a format suited for data communications on the Internet 13 and then transmits the provided data through the Internet 13 to the user terminal 11. The communication module 32 also converts data received through the public network 12 and the Internet 13 from the user terminal 11 into a data format in the server and then transmits the provided data to the control module 30.

Next, the programs and data used for the congeniality determination operation of the congeniality determination server 14 will be discussed. The programs and data are stored in the storage module 31 as described above.

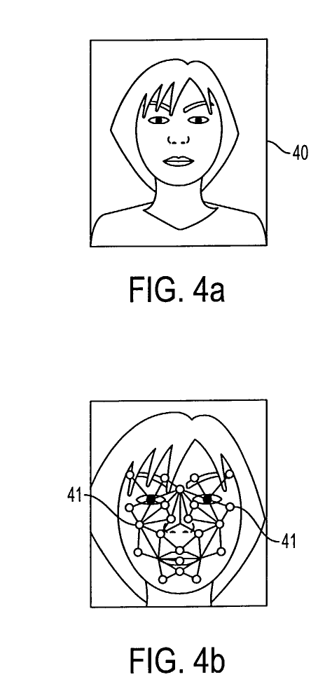

To begin with, the program for extracting the distinctive features of a face from a facial image using an image recognition technique is stored in the storage module 31. Specifically, the image recognition technique is used to extract a face's distinctive features 41 as shown in FIG. 4B from a facial image 40 received from the user terminal 11, as shown in FIG. 4A.

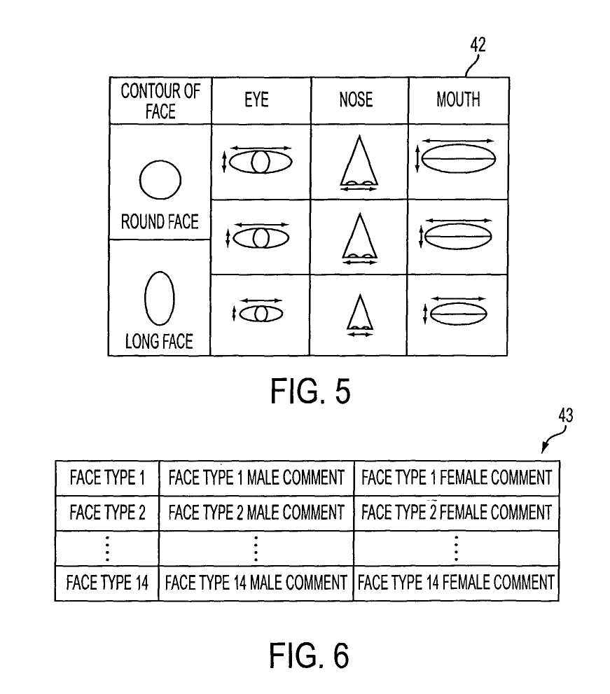

The program for determining the contour of the face (round or long face) and the sizes of the eye, the nose, and the mouth (large, medium, small) as shown in FIG. 5 based on the extracted distinctive features 41 is stored in the storage module 31.

The data of face types, classified based on the distinctive features of the parts of the face, is stored in the storage module 31. A total of 14 face types (face type 1 to face type 14) of six types of large and small eyes, noses, and mouths plus one type of balance type for each of the contours of round and long faces are available in the embodiment.

Face type comment data 43 of face type comments concerning the 14 face types according to the gender (male and female) (2×14=28 face type comments) is stored in the storage module 31 as shown in FIG. 6. Each face type comment includes the character, advice, etc., based the distinctive features of the face.

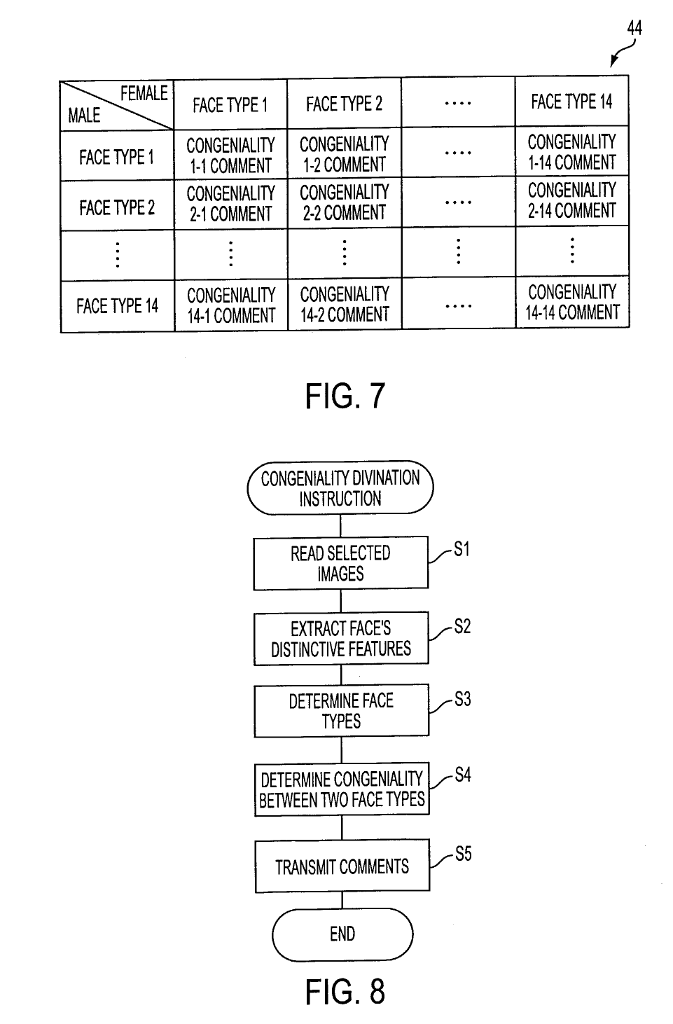

Congeniality comment data 44 of 196 congeniality comments corresponding to combinations of the 14 male face types and the 14 female face types (14 ×14) is stored in the storage module 31 as shown in FIG. 7. Each congeniality comment includes the congeniality contents, advice, etc., in addition to the numeric value indicating the congeniality degree (0%-100%).

The operation of the described congeniality determination system 10 is as follows: To begin with, as the user accesses the congeniality determination server 14 from the user terminal 11, a home page 50 as shown in FIG. 9 is displayed on the display module 22 of the user terminal 11. The home page 50 is provided with a facial image transmission button 51, a facial image registration listing pull-down menus 52 and 54, registered facial image display buttons 53 and 55, a congeniality determination button 56, etc.

As the user uses the photography module 21 of the user terminal 11 to take a photograph, facial image data is prepared. Next, the user selects the facial image transmission button 51, thereby transmitting electronic mail, to which the facial image data and information indicating female or male are attached, to the congeniality determination server 14. Accordingly, the female or male facial image is registered in the congeniality determination server 14. The user can select the registered facial image display button 53 or 55, thereby receiving the registered facial image from the congeniality determination server 14 and displaying the facial image on the display module 22.

In the embodiment, the operation is repeated, whereby a plurality of female and male facial images can be registered. In this case, the user can use the pull-down menu 52, 54 to select any of the registered facial images.

Next, as the user selects the congeniality determination button 56, the congeniality determination server 14 executes congeniality determination processing shown in FIG. 8. First, the male and female facial image data selected by the user using pull-down menus 52 and 54 is read from the storage module 31 (step S1)

Next, a face's distinctive features 41 are extracted from each of the retrieved male and female facial images as shown in FIG. 4B (step S2). Next, the contour of each face and the sizes of the eye, nose, and mouth of each face are determined based on the extracted distinctive features as shown in FIG. 5, and each of the male and female face types is selected from among the 14 predetermined face types based on the determination (step S3). At this time, the face type comments corresponding to the determined male and female face types are retrieved from the face type comment data 43 shown in FIG. 6.

Next, the congeniality comment corresponding to the combination of the determined male and female face types is retrieved from the congeniality comment data 44 shown in FIG. 7 (step S4). The retrieved male and female face type comments and the retrieved congeniality comments together with the home page data of the determination result are transmitted to the user terminal 11 (step S5). The congeniality determination processing is now complete.

At this time, a home page 60 of the determination result shown in FIG. 10 is displayed on the display module 22 of the user terminal 11. The home page 60 indicates the numeric value indicating the congeniality degree in the congeniality comment in CONGENIALITY DEGREE, the male and female face type comments in DIVINATION POINT, and the contents of the congeniality comment in CONGENIALITY BETWEEN TWO PERSONS, whereby the user can acquire information concerning the congeniality.

Therefore, the congeniality determination system 10 of the embodiment enables the user to use the user terminal 11 to transmit two facial images picked up by the photography module 21 to the congeniality determination server 14, thereby acquiring new information of the congeniality between two persons from the congeniality determination server 14.

The user can also acquire the congeniality between two persons based on the face's distinctive features from the congeniality determination server 14 simply by transmitting two facial images from the user terminal 11. Therefore, to acquire the congeniality between two persons based on the face's distinctive features, the user need not transmit several pieces of information indicating the face's distinctive features from the user terminal 11, so that the user can acquire the congeniality between two persons easily from the user terminal 11.

The user can make a congeniality determination by selecting any of various combinations from among faces images of each person stored in the storage module 31 of the congeniality determination server 14 and thus can acquire the congeniality between two persons from various viewpoints by registering a plurality of facial images provided by photographing changed expressions in the congeniality determination server 14, for example.

In the embodiment, the intersexual congeniality is determined, but the invention is not limited to it. For example, the congeniality between friends can also be determined from facial images of friends of the same sex, for example.

As described above, the congeniality determination method of the invention includes the steps of acquiring facial images through a communication network; extracting a face's distinctive features based on the acquired facial images; determining face types based on the extracted face's distinctive features; determining congeniality between two persons corresponding to the combination of two face types determined from the two facial images; and providing the determined congeniality between two persons through the communication network.

Thus, the congeniality determination method provides the advantage that the user can transmit the two photographic images containing facial images from the terminal, thereby acquiring new information of the congeniality between two persons. To acquire the congeniality between two persons based on the face's distinctive features, the user need not transmit several pieces of information indicating the face's distinctive features, so that the congeniality determination method provides the advantage that the user can acquire the congeniality between two persons easily from the user terminal. Particularly, if the terminal is a mobile telephone terminal having a photography function, the user can easily tale a close-up photograph and transmit the provided facial image.

The congeniality determination method of the invention may include the steps of storing a plurality of facial images of each person; and selecting a combination of facial images used for congeniality determination from among the plurality of facial images stored.

Thus, the congeniality determination method provides the advantage that any of various combinations can be selected from among the facial images of each person for making a congeniality determination and therefore the user can acquire various pieces of congeniality information.

The congeniality determination server of the invention is the congeniality determination server communicating through a user terminal and a communication network and includes an input module for receiving facial images through the communication network; a distinctive feature extraction module for extracting a face's distinctive features based on the received facial images; a type determination module for determining face types based on the extracted face's distinctive features; a congeniality determination module for determining congeniality between two persons corresponding to the combination of two face types determined from the two faces images; and a transmission module for transmitting the determined congeniality between two persons through the communication network.

Thus, the congeniality determination server provides the advantage that the user can transmit the two photographic images containing facial images from the terminal, thereby acquiring new information of the congeniality between two persons. To acquire the congeniality between two persons based on the face's distinctive features, the user need not transmit several pieces of information indicating the face's distinctive features, so that the congeniality determination server provides the advantage that the user can acquire the congeniality between two persons easily from the user terminal. Particularly, if the terminal is a mobile telephone terminal having a photography function, the user can easily take a close-up photograph and transmit the provided facial image.

The congeniality determination server of the invention may further include an image storage module being capable of storing a plurality of facial images of each person; and an image selection module for selecting a combination of facial images used for congeniality determination from among the plurality of facial images stored in the image storage module.

Thus, the congeniality determination server provides the advantage that any of various combinations can be selected through the image selection module from among the facial images of each person stored in the image storage module for making a congeniality determination, so that the user can acquire various pieces of congeniality information.

A computer can be caused to execute the congeniality determination method as a congeniality determination program. Further, the congeniality determination program is stored on a computer-readable record medium, whereby the congeniality determination method can be executed on any desired computer.

While the invention has been described and illustrated with reference to specific exemplary embodiments, it should be understood that many modifications and substitutions can be made without departing from the spirit and scope of the invention. Accordingly, the invention is not to be considered as limited by the foregoing description but is only limited by the scope of the appended claims.

What is claimed as new and desired to be protected by Letters Patent of the United States is:

1. A congeniality determination method comprising the steps of:
acquiring facial images through a communication network;
extracting a face's distinctive features based on the acquired facial images;
determining face types based on the extracted face's distinctive features;
determining congeniality between two persons corresponding to a combination of two face types determined from the two facial images; and
providing the determined congeniality between two persons through the communication network.

2. The congeniality determination method as claimed in claim 1 comprising the steps of:
storing a plurality of facial images of each person; and
selecting a combination of facial images used for congeniality determination from among the plurality of facial images stored.

3. A congeniality determination server communicating through a user terminal and a communication network, comprising:
an input module for receiving facial images through a communication network;
a distinctive feature extraction module for extracting a face's distinctive features based on the received facial images;
a type determination module for determining face types based on the extracted face's distinctive features;
a congeniality determination module for determining congeniality between two persons corresponding to combination of two face types determined from the two faces images; and
a transmission module for transmitting the determined congeniality between two persons through the communication network.

4. The congeniality determination server as claimed in claim 3 further comprising:
an image storage module for storing a plurality of facial images of a person; and
an image selection module for selecting a combination of facial images used for congeniality determination from among the plurality of facial images stored in the image storage module.

5. A method for determining a congeniality measure comprising:
acquiring a plurality facial images;
extracting distinctive features of said acquired facial images;
determining face types using said extracted distinctive features; and
determining a congeniality measure corresponding to a combination of face types.

6. A method according to claim 5, wherein said congeniality measure is made between facial images of subjects of the opposite sex.

7. A method according to claim 6, wherein the subjects are of the same sex.

8. A method according to claim 5 further comprising:
providing the congeniality measure to a user.

9. A method according to claim 8, wherein said acquiring act and said providing act are performing via a communications network.

10. A method according to claim 5, further comprising:
storing said plurality of facial images; and
selecting a combination of facial images from among said plurality of stored facial images.

11. A processor for determining a congeniality measure comprising:
an input module for receiving a plurality of facial images;
a distinctive feature extraction module for extracting distinctive features of said received facial images;
a type determination module for determining face types using said extracted distinctive features; and
a congeniality determination module for determining said congeniality measure corresponding to a combination of face types.

12. A processor according to claim 11, wherein said congeniality measure is made between facial images of subjects of the opposite sex.

13. A processor according to claim 11, wherein said congeniality measure is made between facial images of subjects of the same sex.

14. A processor according to claim 11, further comprising:
a transmission module for transmitting said congeniality measure to a user.

15. A processor according to claim 14, wherein said input module and said transmission module communicate with said processor via a communications network.

16. A processor according to claim 15, wherein said processor is a server.

17. A processor according to claim 16, wherein said server is a world wide web (www) server.

18. A processor according to claim 14, wherein said user transmits said plurality of facial images to said processor via a mobile terminal.

19. A processor according to claim 18, wherein said mobile terminal has a capability to acquire said facial images.

20. A processor according to claim 18, wherein said mobile terminal has a capability to accept said facial images from a digital camera.

21. A processor according to claim 18, wherein said mobile terminal has a capability to accept said facial images from a record medium.

22. A processor according to claim 18, wherein said mobile terminal has a capability to accept said facial images from a communications link.

23. A processor according to claim 11, further comprising:
an image storage module for storing said plurality of facial images; and
an image selection module for selecting a combination of facial images from among said plurality of stored facial images.

24. A system for determining a congeniality measure comprising:
a processor; and
a computer-readable storage medium, said computer-readable storage medium having a congeniality determination program executable by said processor and causing said processor to perform the following acts:
acquiring a plurality facial images;
extracting distinctive features of said acquired facial images;
determining face types using said extracted distinctive features; and
determining a congeniality measure corresponding to a combination of face types.

25. A system according to claim 24, wherein said program causes said processor to provide the congeniality measure to a user.

26. A system according to claim 25, wherein said acquiring act and said providing act are performing via a communications network.

27. A system according to claim 24, wherein said program causes said processor to further perform the following acts:
storing said plurality of facial images; and
selecting a combination of facial images from among said plurality of stored facial images.

28. A computer-readable record medium recording a congeniality determination program for causing a processor to perform the following acts:
acquiring a plurality facial images;
extracting distinctive features of said acquired facial images;
determining face types using said extracted distinctive features; and
determining a congeniality measure corresponding to a combination of face types.

29. A computer-readable record medium according to claim 28, wherein said program causes said processor to further provide the congeniality measure to a user.

30. A computer-readable record medium according to claim 29, wherein said acquiring act and said providing act are performing via a communications network.

31. A computer-readable record medium according to claim 28, wherein said program causes said processor to further:
store said plurality of facial images; and
select a combination of facial images from among said plurality of stored facial images.
